(19) United States
(12) Patent Application Publication
(10) Pub. No.: US 2007/0006687 A1
(43) Pub. Date: Jan. 11, 2007

(54) WRENCH EXTENSION

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,701

(22) Filed: Sep. 20, 2005

(30) Foreign Application Priority Data
Jul. 8, 2005 (TW) 94123085

(51) Int. Cl. B25B 13/46; B25B 23/16

(52) U.S. Cl. 81/60; 81/177.8

(57) ABSTRACT

A wrench extension includes a body having an end with a coupling section for releasably coupling with an open end of a handle of a wrench that has an adjustable head pivotably connected to the other end of the handle. The wrench extension further includes a retaining member mounted to the end of the body for securely clamping the open end of the wrench on the end of the body. The retaining member is movable relative to the body to allow coupling of the wrench extension with wrenches with variously sized open ends.

### BACKGROUND OF THE INVENTION

1. Field of the Invention

The present invention relates to a wrench extension. In particular, the present invention relates to a wrench extension for a wrench having an adjustable head on an end thereof.

2. Description of the Related Art

FIG. 1 of the drawings illustrates a conventional wrench 1 comprising a handle 3 and an adjustable head 2 pivotally mounted to the handle 3. The adjustable head 2 can be retained in a desired angular position relative to the handle 3 in response to the environmental conditions, allowing convenient operation. However, operation of the wrench 1 becomes difficult when the adjustable head 2 is at an angle greater than 45 degrees with the handle 3. In a case that the adjustable head 2 is at a right angle with the handle 3 shown in FIG. 1, holding of and application of force to the handle 3 would not be easy during the operation for driving a fastener for loosening or tightening purposes. The time required for complete loosening or tightening is relatively long and the efficiency is poor.

### SUMMARY OF THE INVENTION

In accordance with a first aspect of the present invention, a wrench extension comprises a body including a first end and a second end. The first end comprises a coupling section adapted to releasably couple with an open end of a handle of a wrench. A retaining member is mounted to the first end of the body for securely clamping the open end of the wrench on the first end of the body.

Preferably, the first end of the body comprises a stop, allowing the open end of the wrench to be clamped between the retaining member and the stop.

Preferably, the coupling section comprises a smaller section and a larger section.

Preferably, the larger section comprises an outer threading and the retaining member comprises an inner threading for threadedly engaging with the outer threading of the larger section.

Preferably, the restraining member comprises a plurality of anti-slip ribs on an outer periphery thereof.

Preferably, the wrench extension further comprises a washer between the retaining member and the stop. The open end of the wrench is securely clamped between the washer and one of the retaining member and the stop.

Preferably, the wrench extension further comprises an anti-slip rubber ring mounted to a side of the washer and facing one of the retaining member and the stop

Preferably, the wrench extension further comprising a handle cover mounted to the second end of the body for gripping comfort.

In accordance with a second aspect of the present invention, a wrench extension comprises a body including a first end and a second end. The first end comprises a coupling section adapted to releasably couple with an open end on an end of a handle of a wrench that has an adjustable head pivotably connected to another end thereof. The coupling section comprises a smaller diametrical section and a larger diametrical section. The open end of the wrench has a size ranging from a diameter of the smaller diametrical section to a diameter of the larger diametrical section. A retaining member is mounted to the first end of the body. The retaining member is movable relative to the body for securely and releasably clamping the open end of the wrench on the first end of the body.

Preferably, the first end of the body further comprises a stop, allowing the open end of the wrench to be clamped between the retaining member and the stop.

Preferably, the larger diametrical section comprises an outer threading and the retaining member comprises an inner threading for threadedly engaging with the outer threading of the larger diametrical section.

In accordance with a third aspect of the present invention, a combination of a wrench and a wrench extension is provided. The wrench comprises a handle, an open end on a first end of the handle, and an adjustable head on a second end of the handle. The adjustable head is retainable in a desired angular position relative to the handle. The wrench extension comprises a body including a first end and a second end. The first end of the body comprises a coupling section for releasably coupling with the open end of the wrench. A retaining member is mounted to the first end of the body. The retaining member is movable relative to the body for securely and releasably clamping the open end of the wrench on the first end of the body.

Preferably, the first end of the body comprises a stop, allowing the open end of the wrench to be clamped between the retaining member and the stop.

Preferably, the coupling section comprises a smaller section and a larger section.

Preferably, the larger section comprises an outer threading and the retaining member comprises an inner threading for threadedly engaging with the outer threading of the larger section.

Preferably, the body extends in a direction substantially perpendicular to an extending direction of the handle of the wrench.

Preferably, the wrench extension further comprises a handle cover mounted to the second end of the body for gripping comfort.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a conventional wrench with an adjustable head.

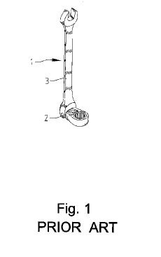

FIG. 2 is an exploded perspective view of a conventional wrench with an adjustable head and a wrench extension in accordance with the present invention.

FIG. 3 is an exploded perspective view of the wrench extension in accordance with the present invention.

FIG. 4 is a sectional view illustrating coupling of the wrench extension in accordance with the present invention and a small-size open end of the wrench.

FIG. 5 is a partly-sectioned side view coupling of the wrench extension in accordance with the present invention and the small-size open end of the wrench.

FIG. 6 is a sectional view illustrating coupling of the wrench extension in accordance with the present invention and a large-size open end of the wrench.

FIG. 7 is a sectional view illustrating coupling of the wrench extension in accordance with the present invention and a medium-size open end of the wrench.

FIG. 8 is a partly-sectioned side view similar to FIG. 5, illustrating a modified embodiment of the present invention.

FIG. 9 is a perspective view illustrating another modified embodiment of the wrench extension in accordance with the present invention.

### DETAILED DESCRIPTION OF THE PREFERRED EMBODIMENTS

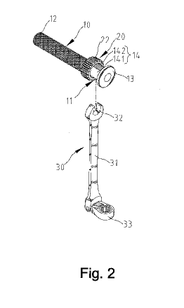

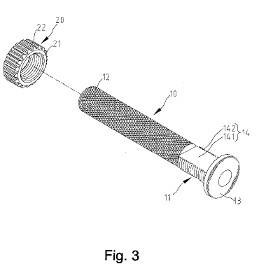

Referring to FIGS. 2 and 3, a wrench extension in accordance with the present invention comprises a body 10 and a retaining member 20. The body 10 comprises a first end 11 and a second end 12. The first end 11 of the body 10 comprises a stop 13 and a coupling portion 14. In this embodiment, the coupling portion 14 comprises a smaller diametrical section 141 and a larger diametrical section 142 including an outer threading. The second end 12 may be embossed to avoid slipping.

The retaining member 20 is mounted on the first end 11 of the body 10 and movable along a longitudinal direction of the body 10. In this embodiment, the retaining member 20 is a hollow member comprising an inner threading 21 for threadedly engaging with the larger diametrical section 142 of the body 10. Thus, the retaining member 20 can be manually turned to the desired longitudinal position on the body 10. Preferably, the retaining member 20 includes anti-slip ribs 22 on an outer periphery thereof to allow manual easy turning of the retaining member 20.

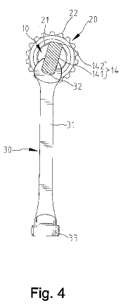

Referring to FIG. 4, in a case that operation of an adjustable head 33 of a wrench 30 in a deep hole or restricted area is required, the adjustable head 33 is pivoted to and retained in a position at, e.g., a right angle with a handle 31 of the wrench 30. The user may couple the wrench extension in accordance with the present invention with an open end 32 of the wrench 30.

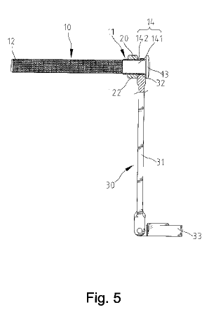

As illustrated in FIGS. 4 and 5, the coupling section 14 of the body 10 is coupled with the open end 32 of the wrench 30. Next, the retaining member 20 is turned until the open end 32 of the wrench 30 is securely clamped between the stop 13 of the body 10 and the retaining member 20. Thus, the wrench extension is coupled to the wrench 30 to move therewith, as the smaller diametrical section 141 is securely held between the jaws (not labeled) of the open end 32 of the wrench 30. It is noted that the body 10 of the wrench extension extends in a direction substantially perpendicular to that of the handle 31 of the wrench 30, the user may grip the second end 12 of the body 10 easily. An ergonomic design is thus provided. The force applied to the body 10 can be effectively transmitted to the handle 30. Thus, a fastener (not shown) engaged with the adjustable head 33 of the handle 30 can be effectively driven for tightening/loosening purposes. The operation time is shortened and the operational efficiency is improved.

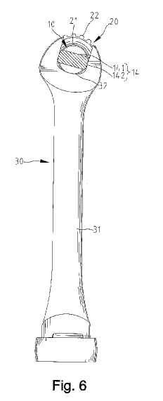

The open end 32 of the wrench 30 in FIGS. 4 and 5 has a size equal to a size (the diameter in this example) of the smaller diametrical section 141 of the body 10. In a case that the open end 32 of the wrench has a larger size equal to a size (the diameter in this example) of the larger diametrical section 142 of the body 10, the larger diametrical section 142 is securely held between the jaws of the open end 32 of the wrench 30, as shown in FIG. 6.

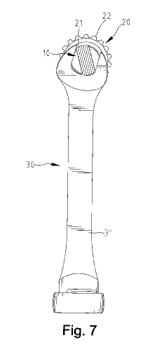

In a case that the size of the open end 32 of the wrench 30 is between the diameter of the smaller diametrical section 141 and the diameter of the larger diametrical section 142 of the body 10, the coupling section 14 of the body 10 can be coupled to the open end 32 of the wrench 30 in a slanted state, as illustrated in FIG. 7. Thus, the wrench extension in accordance with the present invention can be used to couple a wrench with an open end having a size ranging from the diameter of the smaller diametrical section 141 to the length of the larger diametrical section 142 of the body 10. Namely, the wrench extension in accordance with the present invention can be used with a set of wrenches with variously sized open ends.

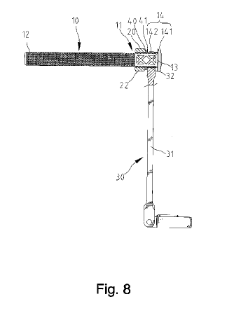

FIG. 8 illustrates a modified embodiment of the invention, wherein a washer 40 is mounted between the retaining member 20 and the open end 32 of the wrench 30. Preferably, an anti-slip rubber ring 41 is mounted to a side of the retaining member 20 facing the stop 13. The washer 40 provides a firmer clamping effect for the open end 32 of the wrench 30. In an alternative arrangement, the washer 40 is mounted between the stop 13 and the other side of the retaining member 20.

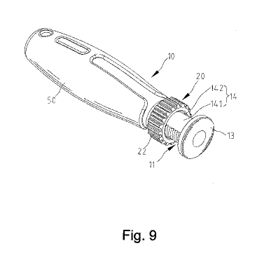

FIG. 9 illustrates another modified embodiment of the invention, wherein the wrench extension further comprises a handle cover 50 mounted to the second end 12 of the body 10 for gripping comfort.

Although specific embodiments have been illustrated and described, numerous modifications and variations are still possible without departing from the essence of the invention. The scope of the invention is limited by the accompanying claims.

What is claimed is:

1. A wrench extension comprising:
a body comprising a first end and a second end, the first end comprising a coupling section adapted to releasably couple with an open end of a handle of a wrench; and
a retaining member mounted to the first end of the body for securely clamping the open end of the wrench on the first end of the body.

2. The wrench extension as claimed in claim 1, with the first end of the body comprising a stop, allowing the open end of the wrench to be clamped between the retaining member and the stop.

3. The wrench extension as claimed in claim 1, with the coupling section comprising a smaller section and a larger section.

4. The wrench extension as claimed in claim 2, with the coupling section comprising a smaller section and a larger section.

5. The wrench extension as claimed in claim 3, with the larger section comprising an outer threading and with the retaining member comprising an inner threading for threadedly engaging with the outer threading of the larger section.

6. The wrench extension as claimed in claim 5, with the restraining member comprising a plurality of anti-slip ribs on an outer periphery thereof.

7. The wrench extension as claimed in claim 2, with the wrench extension further comprising a washer between the retaining member and the stop, with the open end of the wrench being securely clamped between the washer and one of the retaining member and the stop.

8. The wrench extension as claimed in claim 7, with the wrench extension further comprising an anti-slip rubber ring mounted to a side of the washer and facing one of the retaining member and the stop.

9. The wrench extension as claimed in claim 1, with the wrench extension further comprising a handle cover mounted to the second end of the body for gripping comfort.

10. A wrench extension comprising:
a body comprising a first end and a second end, the first end comprising a coupling section adapted to releasably couple with an open end on an end of a handle of a wrench that has an adjustable head pivotably connected to another end thereof, the coupling section comprising a smaller diametrical section and a larger diametrical section, the open end of the wrench having a size ranging from a diameter of the smaller diametrical section to a diameter of the larger diametrical section; and
a retaining member mounted to the first end of the body, the retaining member being movable relative to the body for securely and releasably clamping the open end of the wrench on the first end of the body.

11. The wrench extension as claimed in claim 10, with the first end of the body further comprising a stop, allowing the open end of the wrench to be clamped between the retaining member and the stop.

12. The wrench extension as claimed in claim 10, with the larger diametrical section comprising an outer threading and with the retaining member comprising an inner threading for threadedly engaging with the outer threading of the larger diametrical section.

13. A combination of a wrench and a wrench extension, comprising: a wrench comprising a handle, an open end on a first end of the handle, and an adjustable head on a second end of the handle, the adjustable head being retainable in a desired angular position relative to the handle; and
a wrench extension comprising:
a body comprising a first end and a second end, the first end of the body comprising a coupling section for releasably coupling with the open end of the wrench; and
a retaining member mounted to the first end of the body, the retaining member being movable relative to the body for securely and releasably clamping the open end of the wrench on the first end of the body.

14. The combination as claimed in claim 13, with the first end of the body comprising a stop, allowing the open end of the wrench to be clamped between the retaining member and the stop.

15. The combination as claimed in claim 13, with the coupling section comprising a smaller section and a larger section.

16. The combination as claimed in claim 15, with the larger section comprising an outer threading and with the retaining member comprising an inner threading for threadedly engaging with the outer threading of the larger section.

17. The combination as claimed in claim 14, with the coupling section comprising a smaller section and a larger section.

18. The combination as claimed in claim 17, with the larger section comprising an outer threading and with the retaining member comprising an inner threading for threadedly engaging with the outer threading of the larger section.

19. The combination as claimed in claim 13, with the body extending in a direction substantially perpendicular to an extending direction of the handle of the wrench.

20. The combination as claimed in claim 13, with the wrench extension further comprising a handle cover mounted to the second end of the body for gripping comfort.
